(19) United States
(12) Patent Application Publication
(10) Pub. No.: US 2002/0091775 A1
(43) Pub. Date: Jul. 11, 2002

(54) System and method for universal email

(76) Inventors: Graham A. Morehead, Cambridge, MA (US); Armen Y. Skenderian, Danvers, MA (US); Harris L. Gilliam, Somerville, MA (US)

Correspondence Address: LOCKE LIDDELL & SAPP LLP, 600 TRAVIS, 3400 CHASE TOWER, HOUSTON, TX, 77002-3095, US

(21) Appl. No.: 09/947,293

(22) Filed: Sep. 5, 2001

Related U.S. Application Data
(60) Provisional application No. 60/232,849, filed on Sep. 15, 2000.

(51) Int. Cl. G06F 15/16

(52) U.S. Cl. 709/206; 709/218; 709/219

(57) ABSTRACT

System and method that enables any remote device to act as a view to an email server. In a preferred embodiment, the system and method are fully interactive with read, write, send, delete, forward, reply, and similar functions. Complementary to customary methods of email usage, the system uses a server capable of storing pertinent data for multiple email accounts, and communicating with any computer or two-way communication device such that the system may accomplish all standard email functionalities.

This application relies upon U.S. Provisional Patent Application Serial No. 60/232,849 filed Sep. 15, 2000.

### FIELD OF THE INVENTION

The field of the invention is in the area of mobile data communications, including electronic mail.

### BACKGROUND OF THE INVENTION

Since the advent of the Internet, electronic mail (“email”) has become a staple communication medium. It has become so ubiquitous as to inspire the popular renaming of standard postal mail as “snail mail.” Until the proliferation of two-way data devices, however, email was only used through stationary machines. Various new mobile devices now allow email interaction through wireless connections, but there are holes in present offerings.

One gap in the present art is that of an email client which will function in a reasonably similar fashion on all devices. Commonly, this type of technology is designed for a specific device. Someone who has more than one device or obtains a new device, has to learn a new system and set it up separately. Even if a user can get his email on all devices, there is in the present art a hurdle of complexity, which must be overcome to enable such convenience. Only with the presented invention can email be accessed from all devices with a similar user interface (“UI”) and unified account management.

Another common gap in the present art is that of clients which connect to multiple email accounts and present them in a UI that allows easy interaction with all accounts simultaneously. Most allow connection to one account and some only allow connection to an account on the carrier's system which does not help a user in any way to connect to accounts that are already in use.

If a software package does allow connection to multiple accounts there are commonly two weaknesses: The UI does not allow easy interaction with both accounts simultaneously, nor does it allow a user to receive a message from one account and forward it using another account. Involved in these features are a number of flexibilities that were not available before the invention. Therefore a need exists that solves these problems.

### SUMMARY OF THE INVENTION

System and method that enables any remote device to act as a view to an email server. In a preferred embodiment, the system and method are fully interactive with read, write, send, delete, forward, reply, and similar functions. Complementary to customary methods of email usage, the system uses a server capable of storing pertinent data for multiple email accounts, and communicating with any computer or two-way communication device such that the system may accomplish all standard email functionalities.

In one embodiment, the system and its method of use are capable of displaying extension of email functionality to a remote device. This system typically comprises a server connected to a wide area network capable of communicating with at least one email server and simultaneously answering hypertext transfer protocol (“HTTP”) requests from other computers or communication devices; a listener module existing on the server, wherein the listener module is capable of sensing HTTP requests coming into a given port, a post office protocol (“POP”) module existing on the server, wherein the POP module is capable of retrieving email headers and messages from an email server using POP; a simple mail transfer protocol (“SMTP”) module existing on the server, wherein the SMTP module is capable of sending email messages to a given server; a remote device capable of making HTTP requests from an originator of the request and displaying results of the HTTP requests; and a translator module existing on the server, wherein the translator module is capable of translating the result of HTTP requests into a markup language for the originator of the request.

In a preferred embodiment, the wide area network is the Internet. Moreover, the remote device is preferably a computer or similar communication device. In a most preferred embodiment, the system further comprises an Internet message address protocol (“IMAP”) module existing on the server, wherein the IMAP module is capable of retrieving email headers and messages from an email server using IMAP.

### BRIEF DESCRIPTION OF THE DRAWINGS

The objects, features, and advantages of the invention will become apparent from the following detailed description presented in connection with the accompanying drawings.

FIG. 1 shows a diagram of one embodiment of the hardware configuration;

FIG. 2 shows a flow chart of one embodiment of the process;

FIG. 3 shows a diagram of one embodiment of the software configuration; and

FIG. 4 shows a flow chart of one embodiment of the software process flow.

Those skilled in the art will recognize that the embodiments depicted by the flow charts and diagrams represent some of a virtually infinite variety of combinations or permutations of the elements depicted herein. The rearrangement, reclassification, combination, permutation, substitution, insertion, deletion, or any other selection or arrangement of elements in this configuration should be considered to be within the scope of the invention as described and claimed herein.

### DETAILED DESCRIPTION OF PREFERRED EMBODIMENTS

Those skilled in the art will recognize that substantial deviation from the following description of the preferred embodiment is to be within the scope of the invention. Notably, a few terms that are used within this application merit definition. Those terms are as follows.

Client is used herein as a program that runs on a typically smaller or remote device and connects to a server for computation or function that requires a more capable machine. Email Server is used herein as a server based program that listens on a standard port for incoming emails and stores them. Upon request these messages are retrieved from the server. The Operating System on which any of these programs may run is referred to as the “OS.”

Post Office Protocol (“POP”) is the most commonly used protocol used to retrieve email from an email server. It consists of a standard list of commands and responses passed over a Telnet connection. POP3 is the standard form. Simple Mail Transfer Protocol (“SMTP”) is a protocol for sending email messages between servers.

Internet Message Access Protocol (“IMAP”) is like POP, but allows more use of the server and control thereof. Personal Data Assistant (“PDA”) is a small handheld device capable of running applications and thin clients. This device may be connected with a modem, wireless, or otherwise. User Interface (previously defined as UI), a graphical user interface (“GUI”), it is a term used to describe the design and flow of any dialogues between a device and a user.

A distinction needs to be made between software and hardware components of the invention. These two classes of components are in essence parallel to each other and are not necessarily segmented in the same fashion.

The hardware component of the client allows the user to connect to the invention with a remote device. This device could take the form of a web-enabled phone, a twoway pager, a PDA with a modem, or simply a personal computer (“PC”) with a connection to a wide area network such as the Internet. Remote devices capable of taking advantage of the present invention include, but are not limited to computers, portable computers, handheld portable computers, palm-top portable computers, personal computers, palm-size personal computers, personal computer notebooks, handheld organizers, phones, personal digital assistants, laptops, wireless phones, cell phones, cellular phones, digital phones, pagers, Internet appliances, wearables, and similar devices. From this device the user opens software which makes connections to the other components of the invention.

The software component of the client allows the user to interact with the system through a client UI. This interface gives the user access to read his or her email, send email, and accomplish all expected email functions. Depending on the actual hardware, the interface will be comprised of a selection of browser based screens or screens developed for the OS of that device.

The typical client software used with this invention is a browser-based piece that operates only according to a “pull” model. The user must refresh their view in order to view new mails. Under this scenario, any interaction with the Server component is initiated at the remote device and never the other way around.

The hardware component of the server is a machine that has a wide area network connection and preferably plenty of processing power to supply the corresponding user base. This machine houses all software components with the exception of the client. In a preferred embodiment, the wide area network is the Internet.

The software component of the server, upon receiving an event, the server carries out the actions required and returns a response if necessary. In the case that the request is the retrieval of email headers from a certain account, the server opens up a connection to a typical email server to retrieve them On a lower lever this action consists of a Telnet connection and standard handshakes and conmands that email servers understand.

There is a command that asks for the headers of the emails waiting on the server. There is another command that asks for the body of a specific message. There are other commands to download all the waiting emails and another to erase them from the server. Whatever the need, the server takes care of all of these functions in such a way that the user need not be concerned with the lower level operations.

Notably, the server will only be able to present emails that are still on the email server. If a user has deleted or cleaned emails off of the server, as is the default action with most PC-based email clients, these emails will no longer retrievable by the server component of the invention. The invention can only retrieve what is on the server, not what the user has already downloaded to another machine.

It is apt to make notice here of the differing function of an IMAP email server. A POP3 Email server and client favor the following operation: the client creates a section on the hard disk for saving emails and creating folders; when connected to the email server, the client downloads all waiting emails and then deletes them from off the server. The IMAP scenario, however, leaves everything on the server. All organizational folders which are created to organize the already read emails exist on the server instead of the client device or PC. The user of an IMAP account would therefore have all their email visible through the invention—new and old. It should also be noted that most email servers can operate in both modes: IMAP and POP3.

The software component of the database contains all user information, such as the login name and password for each account. When a user requests his email, he is not forced to reenter this information each time. There is an ease and convenience that can be simultaneously applied to multiple accounts.

In another embodiment of the invention, this database is used for security purposes. The hardware identification (“ID”) of the remote device can be setup to be the only device authorized to access the server. When the user logs on to the invention from another device, access can be denied because the hardware ID of the remote device doesn't match the one stored in the database.

The software component of the login allows the UI to present the user first with a login. The login can be hidden and automatic if desired—based on hardware ID or key generators. After the login, the user is presented with links to their different email accounts and other options on the main page.

The software component may include a main page. The main page is a UI that preferably lists some or all of the following links: one link to check each email account; check all accounts; send Mail; and settings.

The first item on the list will typically list the name of the account according to the settings. The text of this link will also include the number of unread messages that are waiting.

The software component called CHECK ACCOUNT/RETRIEVE EMAIL allows the user to check his or her mail. The client issues a request to the server, which ummediately checks to see if there are any messages waiting on the server. In the case that messages are waiting, their respective headers are displayed in a list for the user to choose from.

Each header is a link to another servlet which when activated retrieves the contents of that email and sends it to the remote device. The UI allows the user to Reply to, Delete, Forward the email, or return to the Header Listing.

Although separate modules may be utilized to interact with POP3 and IMAP email servers, this fact should be invisible to the user. Their interaction will be externally identical in both situations.

The software component called SEND MAIL allows a user to send mail. This mail can be sent directly by the Server component. The user enters all needed information into the Client side UI. Upon receipt, the server component packages the data as a standard email and initiates the SMTP send module.

Although direct contact with the email server for the user's account is not necessary for SMTP, the “from” field must be filled. In the Client side UI there is a drop down list containing each of that user's accounts.

The software component called SENT MAIL allows all messages sent using the invention to be stored such that they can be browsed and retrieved at a later date. A user can view the headers of past sent emails by selecting “Sent Mails” from either the header list for one account, or the header list for all accounts. If a user makes this selection from the list for a specific account, they will view only the sent mails pertaining to that account. These email headers can be sorted by to whom they were sent, or when they were sent, or the subject.

The software component called SETTINGS is the component that allows direct interaction with the database. Through a collection of servlets that access the database, a user can add an account, Remove an account, or Edit account settings. These settings include but are not limited to login name, password, mail server (e.g. “mail. superwings.com”), and the name you want others to see when they receive an email from you.

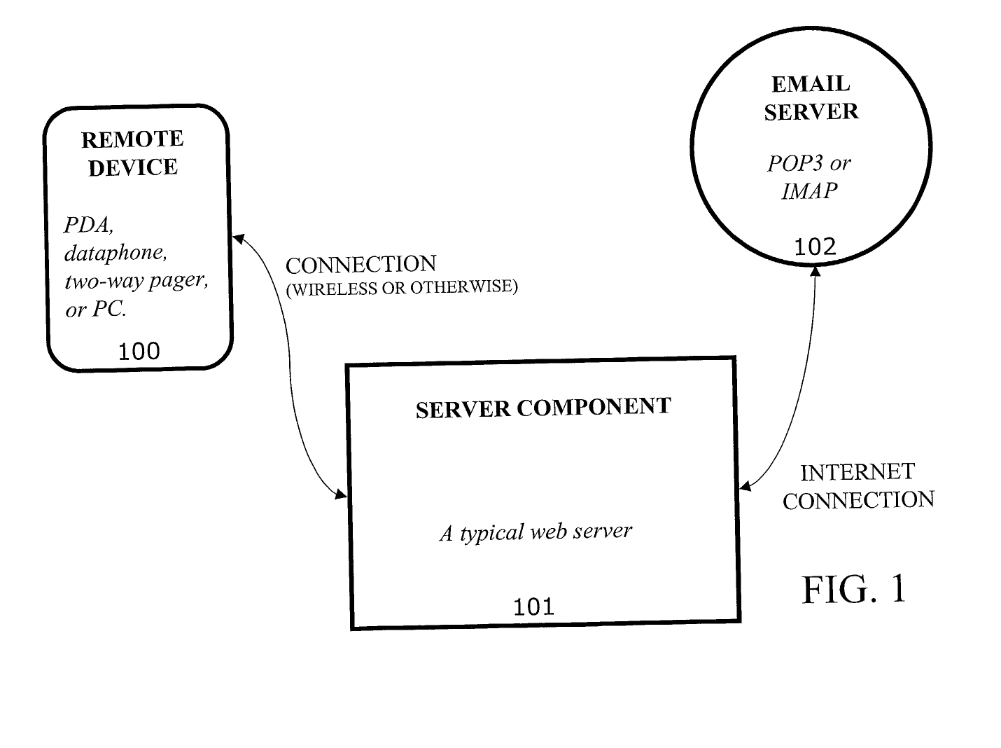

Referring to FIG. 1, a schematic of an embodiment of the two components of the invention and an email server is shown. The first component is the remote device 100. This device should be able to initiate two-way communication with the server component 101. The communication can be through a typical wide area network, such as the Internet, or wireless connection. The use of the invention will be most applicable to situations where the wireless connection is the only one available. Some examples are Wireless Application Protocol (“WAP”) phones, two-way pagers, and PDAs with modems.

The second component is the Server Component 101. This server should be able to behave as a typical Web server. It must also be able to run servlets that can complete other actions such as opening Telnet connections. In the case that remote device 100 initiates an email download request via a hypertext transfer protocol (“HTTP”) connection, a servlet is activated on Server Component 101 which opens a Telnet to Email Server 102. The email is downloaded and the Telnet connection to 102 is closed. Next, Server Component 101 sends the email to remote device 100 in a compatible format.

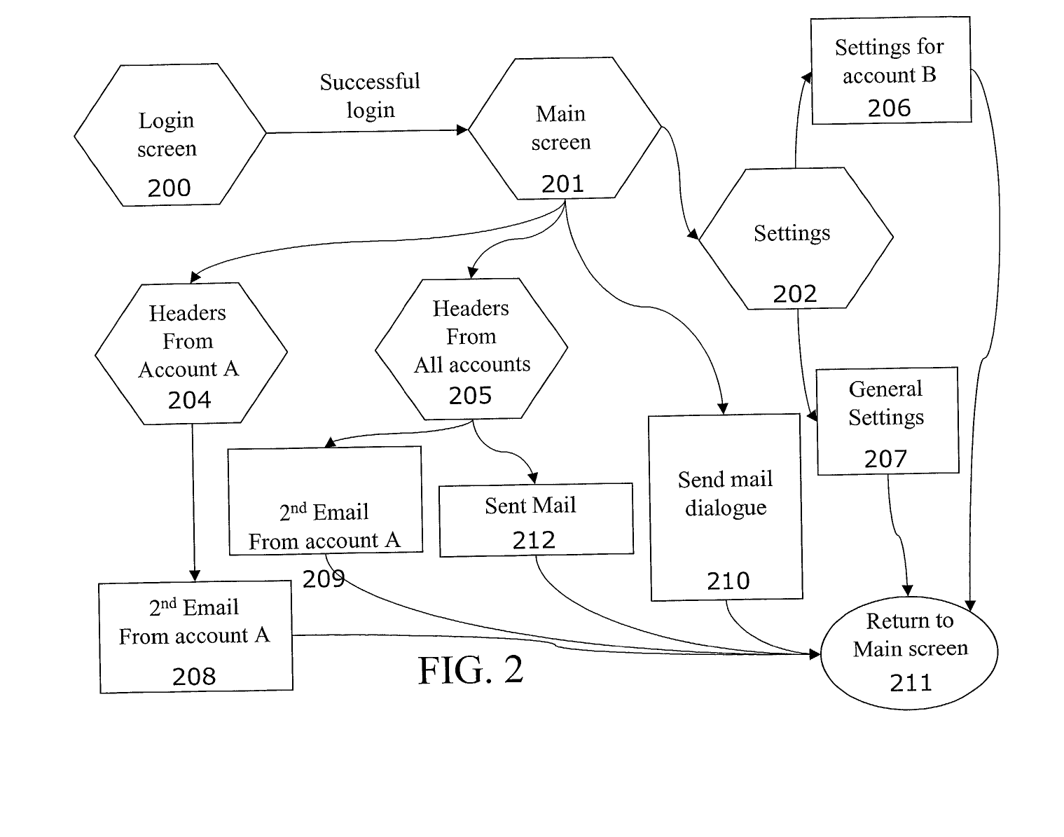

FIG. 2 shows a possible flow experienced by a user of the invention. Those skilled in the art will recognize that the operation of the invention is not limited to this example. In a typical embodiment, the first thing the user is presented with is the login screen 200. The user must enter one username and password, but will then no longer have to enter any more logins, even for multiple accounts. The Main Screen 201 has one link to check the email on each of the user's accounts, and one link that checks the email from all accounts. There is a separate link for Sending mail and another link for Settings.

Selecting their first account brings the user to block 204 in the diagram Here the user is presented with another list of links, each one showing the sender, date, and/or subject of each email waiting to be read on that particular email server. By clicking on the link referring to the second email the user is brought to block 208 in the diagram Since there is also a link on the Main Page referring to all accounts, the user can get to the same email by first selecting “All Accounts,” (bringing them to block 205 in the diagram), and then selecting the header referring to that email from the list, thus bringing them to block 209. A user can also browse emails sent in the past via another link on 205. Upon selecting this link the user is presented with list of headers in block 212 of past emails, each one readable upon selection.

Selecting “Send Mail” from the Main Screen brings the user to a dialogue box 210 containing all the necessary fields for sending mail: target address(s), account user is sending from, Carbon Copy (“CC”), Blind Carbon Copy (“BCC”), and the text of the message. When finished, the user selects the “Send” button. They are given confirmation of delivery and then redirected back to the Main Screen 211.

Selecting “Settings” presents the user with a list of links 202; one for each account and a link for “General Settings.” Selecting Account B initiates a settings module 206 which allows the user to change any field that corresponds to Account B: username, password, outgoing SMTP server, incoming, POP3/IMAP, etc. Selecting “General” initiates a module 207 which allows the user to change how long a timeperiod to save sent messages, create new account, make changes to all accounts, etc. After making changes the user can easily return to the Main Screen.

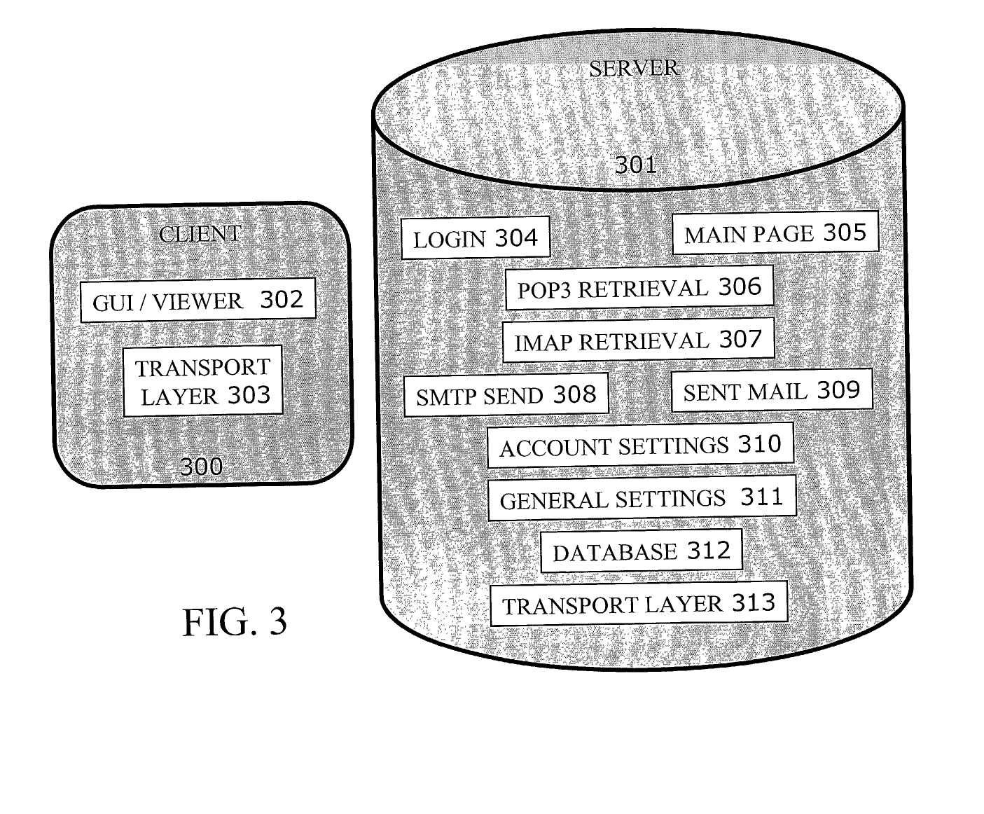

FIG. 3 shows the separation of function between the Client 300 and Server components 301. The client software includes a Transport Layer 303 and a GUI 302, which has very little content stored locally. It acts as a viewer for screens received from the server component.

The server software may include other modules. Module 304 is a dialogue box for username and password, and a servlet that authenticates the validity of these two pieces of information. Module 305 is a servlet that displays all top-level email functions as links to other servlets and displays messages when necessary, such as confirmation of an email being sent.

In order to retrieve email, one of the retrieval modules must be activated. For POP3 email retrieval, module 306 is used, and module 307 for IMAP. Both retrieve account information from the Database 312. The SMTP module 308 is activated to send email. To browse past sent emails, module 309 is used. The Account Settings module 310 is a collection of servlets that access the Database 312 to change settings for one account. Module 311 adjusts settings for all accounts and for the UI. The transport layer 313 contains all necessary classes with which to communicate with the client.

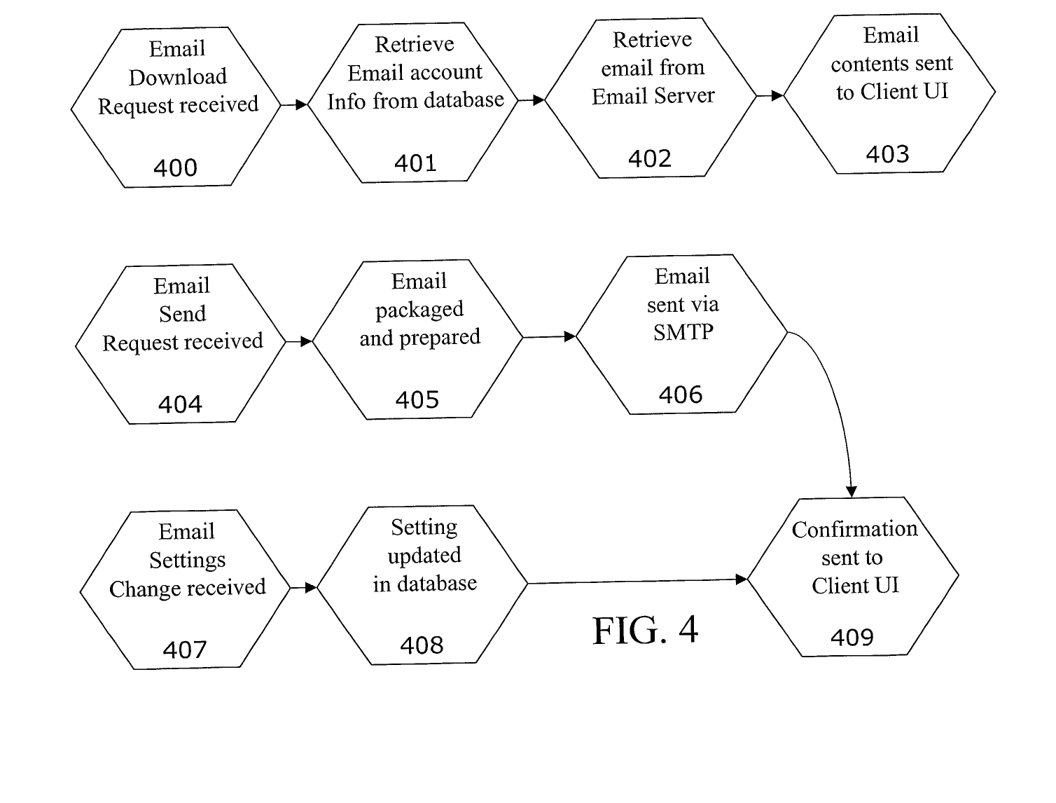

FIG. 4 shows a diagram of the flow of the server based modules upon receipt of different requests. In this embodiment, email download request step 400 initiates access of the database in step 401. Once retrieved in step 402, the email is sent back to the user in step 403.

When a request to send an email step 404 is received, it is put into standard email format with a header and body by step 405, and then send via SMTP by step 406, and then confirmation step 409 is sent to the Client UI. When a user changes a field in his or her settings step 407, this change is submitted to the database step 408, and then confirmation step 409 is sent to the Client UI.

Those skilled in the art will also recognize that substantial variation from the components that have been used in this explanation is to be envisioned within this scope of this invention. Moreover, the embodiment of this system and its method of use as disclosed herein should not be limited to the preferred embodiment disclosed.

This system and method, and many of its intended advantages, will be understood from the disclosure herein and it will be apparent that, although the invention and its advantages have been described in detail, various changes, substitutions, and alterations may be made in the form, construction, and/or arrangement of the elements without departing from the spirit and scope of the invention, or sacrificing its material advantages, the form described previously and subsequently herein as being merely a preferred or exemplary embodiment thereof.

What is claimed is:

1. A system capable of extending email functionality to a remote device, wherein the remote device is capable of accepting HTTP requests from an originator, sending the HTTP requests to a server, receiving the results of the request from said server, and displaying the results, the system comprising:
a server connected to a wide area network;
a listener module existing on the server;
a POP3 module existing on the server;
a SMTP module existing on the server; and
a translator module existing on the server.

2. The system of claim 1, wherein the remote device is a computer.

3. The system of claim 1, further comprising an IMAP module existing on the server, wherein the IMAP module is capable of retrieving email headers and messages from an email server using IMAP.

4. The system of claim 1, wherein the wide area network is the Internet.

5. The system of claim 1, wherein the server is capable of communicating with at least one email server and simultaneously answering HTTP requests from other computers or communication devices.

6. The system of claim 1, wherein the listener module is capable of sensing HTTP requests coming into a given port.

7. The system of claim 1, wherein the POP3 module is capable of retrieving email headers and messages from an email server using POP3.

8. The system of claim 1, wherein the SMTP module is capable of sending email messages to a given server.

9. The system of claim 1, wherein the translator module is capable of translating the result of HTTP requests into a markup language for the originator of the request.

10. A system for the extension of email functionality to a remote device, wherein the remote device is capable of making remote socket requests and displaying results, the system comprising:
a server connected to a wide area network capable of communicating with email servers and simultaneously communicating with other computers or communication devices;
a listener module existing on the server, wherein the listener module is capable of sensing remote socket requests coming into a given port;
a POP3 module existing on the server, wherein the POP3 module is capable of retrieving email headers and messages from an email server using POP3;
an SMTP module existing on the server, wherein the SMTP module is capable of sending email messages to a given server; and
a translator module existing on the server, wherein the translator module is capable of translating the results of remote socket requests into a markup language for the device from which the request originated.

11. The system of claim 10, wherein the remote device is a computer.

12. The system of claim 10, wherein the remote device is a communications device.

13. The system of claim 10, wherein the wide area network is the Internet.

14. The system of claim 10 further comprising an IMAP module existing on the server, wherein the IMAP module server is capable of retrieving email headers and messages from an email server using IMAP.

15. The system of claim 14, wherein the wide area network is the Internet.

16. A method for the extension of email functionality to remote device comprising the steps of:
connecting a server to a wide area network;
communicating with at least one email server and simultaneously answering HTTP requests for other computers or communication devices;
sensing HTTP requests from a given port using a listener module existing on the server;
retrieving email headers and messages from an email server using POP3 by using a POP3 module existing on the server;
sending email messages to a given server using an SMTP module existing on the server;
displaying results of HTTP requests using the remote device; and
translating results of the HTTP request into the correct markup language for the device where the request originated, using at least one translator module existing on the server.

17. The method of claim 16, further comprising retrieving email headers and messages from an email server using IMAP.

18. The method of claim 16, wherein the remote device is a computer.

19. The method of claim 16, wherein the remote device is a communication device.

20. The method of claim 16, wherein the wide area network is the Internet.
